(19) United States
(12) Patent Application Publication
(10) Pub. No.: US 2019/0271307 A1
(43) Pub. Date: Sep. 5, 2019

(54) PRESSURE SENSOR DEVICE AND ELECTRICALLY POWERED PUMP

(71) Applicants: NIPPON SEIKI CO., LTD., Nagaoka-shi, Niigata (JP); Nidec Tosok Corporation, Zama-shi, Kanagawa (JP)

(72) Inventors: Yoshihiro KAMIMURA, Nagaoka-shi (JP); Yoshiyuki KOBAYASHI, Zama-shi (JP); Shigehiro KATAOKA, Zama-shi (JP)

(21) Appl. No.: 16/320,125

(22) PCT Filed: Jul. 25, 2017
(86) PCT No.: PCT/JP2017/026809

§ 371 Date: Jan. 24, 2019

(30) Foreign Application Priority Data
Jul. 27, 2016 (JP) 2016-147530

(51) Int. Cl. F04C 2/10; F04C 15/06; G01L 19/14

(52) U.S. Cl. CPC F04C 2/10; F04C 15/06; F04C 2240/81; F04C 2240/30; G01L 19/147

(57) ABSTRACT

A pressure sensor device for an electrically powered pump includes a pressure sensor that measures a pressure of a fluid inside the electrically powered pump, first and second terminals that project from the pressure sensor in a first direction extending toward one side in the horizontal direction, a third terminal that projects from the pressure sensor in a second direction extending toward another side in the horizontal direction, a fourth terminal that projects from the pressure sensor in the second direction and that is electrically connected to the second terminal; a first capacitor that is located on one side, in the horizontal direction, of the pressure sensor and that is connected between the first terminal and the second terminal, and a second capacitor that is located on another side, in the horizontal direction, of the pressure sensor and that is connected between the third terminal and the fourth terminal.

### BACKGROUND OF THE INVENTION

### 1. Field of the Invention

The present disclosure relates to a pressure sensor device and an electrically powered pump.

### 2. Description of the Related Art

A pressure sensor configured to measure a pressure of a fluid is known. For example, in Japanese Patent Laid-Open No. 2004-245599, a pressure sensor attached to a fluid piping is described.

Incidentally, a configuration in which, when a pressure of a fluid inside an electrically powered pump is measured using a pressure sensor, the pressure sensor is disposed in the electrically powered pump is conceivable. However, there is a problem of the size of the electrically powered pump becoming larger due to the pressure sensor simply being disposed in the electrically powered pump as shown in Japanese Patent Laid-Open No. 2004-245599.

### SUMMARY OF THE INVENTION

Exemplary embodiments of the present disclosure provide pressure sensor devices for electrically powered pumps to prevent the size of the electrically powered pumps from becoming larger, and also provide electrically powered pumps including pressure sensor devices.

A pressure sensor device for an electrically powered pump according to an exemplary embodiment of the present disclosure includes a pressure sensor to measure a pressure of a fluid inside the electrically powered pump; a first terminal and a second terminal that project from the pressure sensor in a first direction that extends to one side in a horizontal direction; a third terminal that projects from the pressure sensor in a second direction that extends to the other side in the horizontal direction; a fourth terminal that projects from the pressure sensor in the second direction and is electrically connected to the second terminal; a first capacitor that is disposed on one side of the pressure sensor in the horizontal direction and is connected between the first terminal and the second terminal; and a second capacitor that is disposed on the other side of the pressure sensor in the horizontal direction and is connected between the third terminal and the fourth terminal.

An electrically powered pump according to an exemplary embodiment of the present disclosure includes a shaft that rotates around a central axis that extends in a vertical direction; a motor that rotates the shaft; and a pump that is positioned on one side of the motor in the vertical direction and is driven by the motor via the shaft, wherein the electrically powered pump further includes a pressure sensor device according to an exemplary embodiment of the present disclosure, the first terminal and the second terminal are disposed on one side of the pressure sensor in a circumferential direction, the third terminal and the fourth terminal are disposed on the other side of the pressure sensor in the circumferential direction, and the pressure sensor device is disposed in the electrically powered pump.

According to exemplary embodiments of the present disclosure, there are provided pressure sensor devices for electrically powered pumps that prevent the size of the electrically powered pumps from becoming larger, and electrically powered pumps including such pressure sensor devices.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view showing an electrically powered pump of an exemplary embodiment of the present disclosure.

FIG. 2 is an exploded perspective view showing a pressure sensor device and a pump body of an exemplary embodiment of the present disclosure.

FIG. 3 is a perspective view showing a pressure sensor device and a pump body of an exemplary embodiment of the present disclosure.

FIG. 4 is a perspective view showing a pressure sensor device of an exemplary embodiment of the present disclosure.

FIG. 5 is a plan view showing a pressure sensor device of an exemplary embodiment of the present disclosure.

FIG. 6 is an exploded perspective view showing a pressure sensor device of an exemplary embodiment of the present disclosure.

FIG. 7 is a cross-sectional view showing a pressure sensor device of an exemplary embodiment of the present disclosure and a partially enlarged view of FIG. 1.

FIG. 8 is a cross-sectional view of a pressure sensor device of an exemplary embodiment of the present disclosure when viewed from the upper side.

FIG. 9 is a bottom view showing a pressure sensor device of an exemplary embodiment of the present disclosure.

FIG. 10 is a diagram showing a first terminal, a second terminal, and a first capacitor of an exemplary embodiment of the present disclosure.

### DETAILED DESCRIPTION OF THE PREFERRED EMBODIMENTS

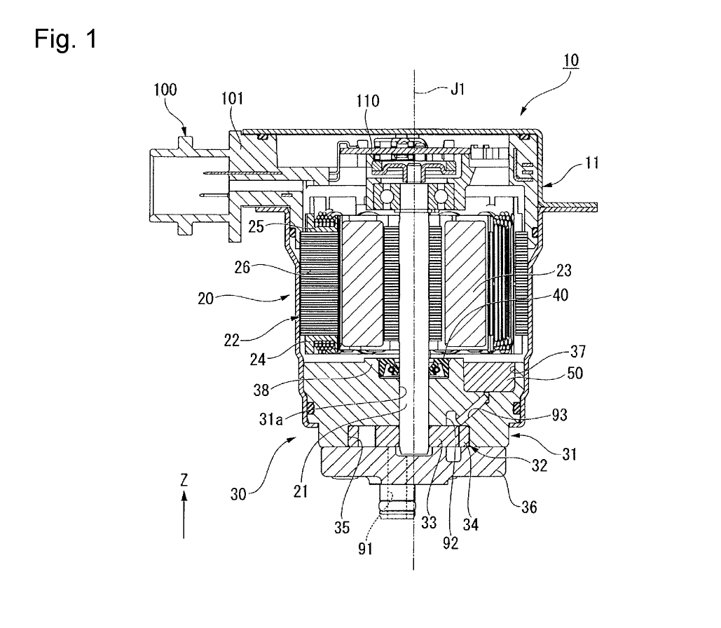

An electrically powered pump 10 of the present embodiment is an electric oil pump that pressurizes and circulates oil as a fluid. As shown in FIG. 1, the electrically powered pump 10 includes a case 11 that houses and holds respective parts of the electrically powered pump 10, a shaft 21 that rotates around a central axis J1, a motor 20 that rotates the shaft 21, a pump 30 that is driven by the motor 20 via the shaft 21, a bus bar unit 100, a circuit board 110, and a pressure sensor device 50. The pressure sensor device 50 is schematically shown in FIG. 1.

The central axis J1 extends in a vertical direction. In the following description, unless otherwise noted, a direction parallel to an axial direction of the central axis J1 will be simply referred to as a “vertical direction,” a radial direction around the central axis J1 will be simply referred to as a “radial direction,” and a circumferential direction around the central axis J1 will be simply referred to as a “circumferential direction.” In the drawings, appropriately, the Z axis extends in a direction parallel to the vertical direction, the positive side on the Z axis is referred to as the “upper side,” and the negative side on the Z axis is referred to as the “lower side.” Here, the vertical direction, the upper side, and the lower side are terms that are simply used for explanation, and do not limit actual positional relationships and directions.

The motor 20 includes a rotor 23 and a stator 22. The rotor 23 is fixed to the outer circumferential surface of the shaft 21. The stator 22 is disposed outward from the rotor 23 in the radial direction and surrounds the rotor 23. The stator 22 includes a stator core 26, an insulator 24 attached to the stator core 26, and a plurality of coils 25 attached to the stator core 26 with the insulator 24 therebetween.

The pump 30 is positioned on one side of the motor 20 in the vertical direction. In FIG. 1, the pump 30 is positioned below the motor 20. The pump 30 includes a pump body 31, a pump gear 32, and a pump cover 36. The pump body 31 is disposed below the motor 20 so that it faces the motor 20 in the axial direction with a gap therebetween. The pump body 31 has a pump chamber 35 in which the pump gear 32 recessed from the lower side surface to the upper side is housed. Although not shown, the shape of the pump chamber 35 when viewed in the vertical direction is a circular shape. The pump body 31 has a through-hole 31a. The through-hole 31a opens at both ends in the vertical direction and the lower side opening opens to the pump chamber 35. The shaft 21 passes through the through-hole 31a.

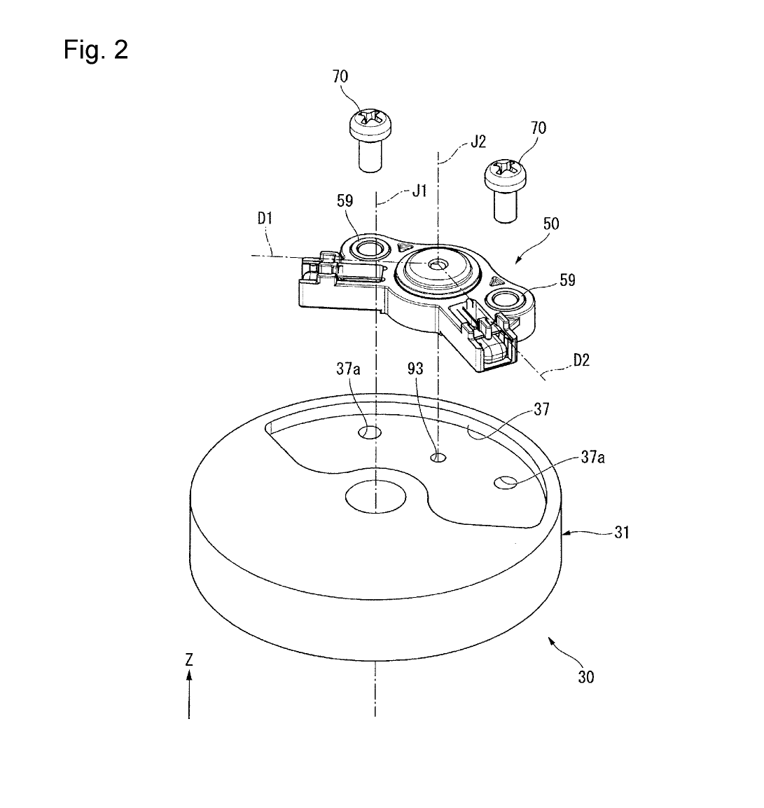

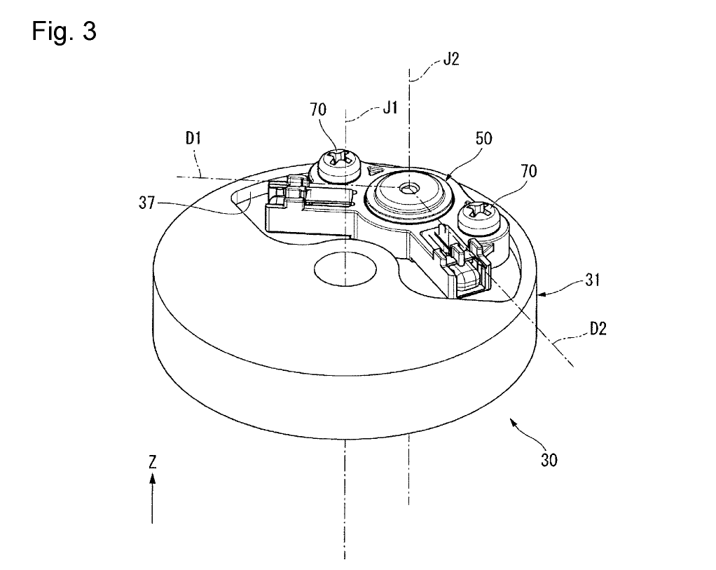

The pump body 31 has a sensor housing recess 37 that is recessed from the upper side surface to the lower side. The sensor housing recess 37 is disposed outward from the through-hole 31a in the radial direction. As shown in FIG. 2, the sensor housing recess 37 has an arc shape that extends in the circumferential direction. On the bottom of the sensor housing recess 37, two female screw holes 37a recessed downward are provided. Here, the sensor housing recess 37 may have an annular shape that extends over one circumference in the circumferential direction. In FIG. 2 and FIG. 3, the pump body 31 is shown in a simplified manner.

As shown in FIG. 1, the pump body 31 has a seal holding part 38 at its center. The seal holding part 38 has a cylindrical shape that opens to the upper side. The seal holding part 38 is disposed inside the sensor housing recess 37 in the radial direction. An oil seal 40 is held inside the seal holding part 38. The inside of the seal holding part 38 communicates with the through-hole 31a. The shaft 21 passes through the inside of the seal holding part 38.

The pump gear 32 rotates according to rotation of the shaft 21. In the present embodiment, the pump gear 32 is attached to the lower end of the shaft 21. The pump gear 32 has an inner rotor 33 fixed to the outer circumferential surface at the lower end of the shaft 21 and an outer rotor 34 that surrounds the outside of the inner rotor 33 in the radial direction. Here, the inner rotor 33 and the shaft 21 may be in a state in which a relative rotation around the central axis J1 is allowed to some extent. The pump cover 36 is attached to the lower side of the pump body 31. The pump cover 36 has a lid shape that extends in the radial direction. The pump cover 36 blocks the lower side opening of the pump chamber 35.

The pump 30 includes an introduction oil path 91, a discharge oil path 92, and a detection oil path 93. In FIG. 1, the introduction oil path 91 is provided in the pump cover 36. The introduction oil path 91 is an oil path which is connected to the pump chamber 35 and introduces oil into the pump chamber 35. In FIG. 1, the discharge oil path 92 is provided in the pump body 31. The discharge oil path 92 is an oil path which is connected to the pump chamber 35 and discharges oil from the pump chamber 35. The detection oil path 93 is an oil path which is provided in the pump body 31 and connects the discharge oil path 92 and the sensor housing recess 37. In FIG. 1, the detection oil path 93 extends radially outward and obliquely upward from the discharge oil path 92. As shown in FIG. 2, the upper end of the detection oil path 93 opens to the bottom of the sensor housing recess 37. A position at which the detection oil path 93 opens at the bottom of the sensor housing recess 37 is, for example, the center between the two female screw holes 37a in the circumferential direction.

As shown in FIG. 1, the bus bar unit 100 is disposed above the motor 20. The bus bar unit 100 includes a bus bar electrically connected to the stator 22, a bus bar electrically connected to the circuit board 110, and a cylindrical bus bar holder 101 that holds each bus bar. The circuit board 110 is held by the bus bar holder 101 inside the bus bar holder 101 in the radial direction. Although not shown, the pressure sensor device 50 is electrically connected to the circuit board 110.

The pressure sensor device 50 is a pressure sensor device for the electrically powered pump 10, and is disposed in the electrically powered pump 10. As shown in FIG. 1 and FIG. 3, the pressure sensor device 50 is housed in the sensor housing recess and is fixed to the pump body 31. A method of fixing the pressure sensor device 50 is not particularly limited. In FIG. 3, the pressure sensor device 50 is fixed to the pump body 31 with two screws 70 fastened to the female screw holes 37a shown in FIG. 2.

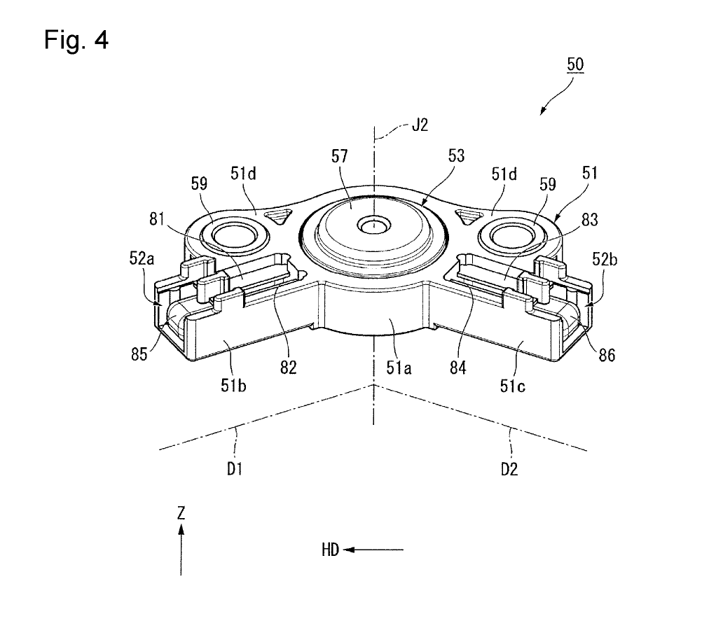

As shown in FIG. 4 to FIG. 6, the pressure sensor device 50 has a flat shape with a relatively small size in the vertical direction. The pressure sensor device 50 includes a pressure sensor 53, a sensor case 51, a first terminal 81, a second terminal 82, a third terminal 83, a fourth terminal 84, a first capacitor 85, and a second capacitor 86. The sensor case 51 houses the pressure sensor 53, the first terminal 81, the second terminal 82, the third terminal 83, the fourth terminal 84, the first capacitor 85, and the second capacitor 86.

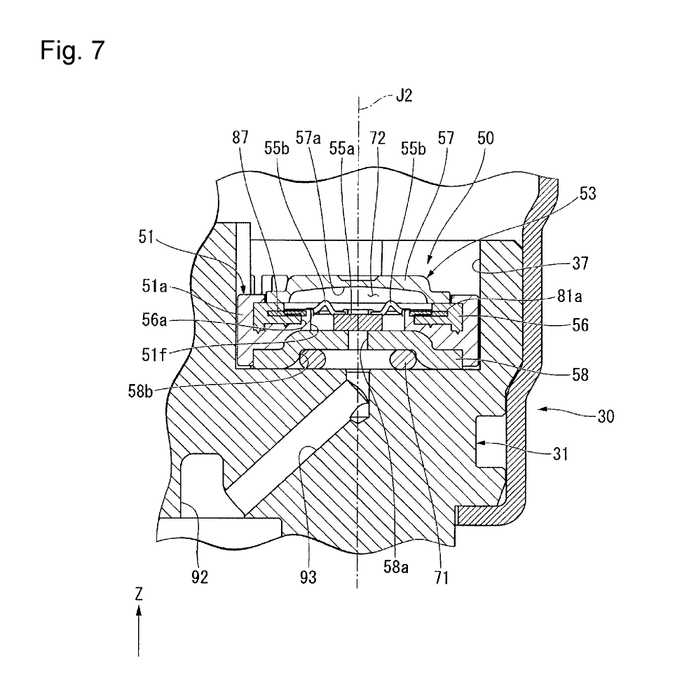

The pressure sensor 53 measures a pressure of a fluid inside the electrically powered pump 10, that is, oil in the present embodiment. The pressure sensor 53 has a flat cylindrical shape in which a sensor central axis J2 passes through its center. The sensor central axis J2 is parallel to the central axis J1 and extends in the vertical direction. As shown in FIG. 2 and FIG. 3, the sensor central axis J2 is disposed away from the central axis J1 in the radial direction. The sensor central axis J2 is positioned at the center of the sensor housing recess 37 in the radial direction. As shown in FIG. 7, the pressure sensor 53 is partially embedded and held in the sensor housing part 51a (to be described below) of the sensor case 51.

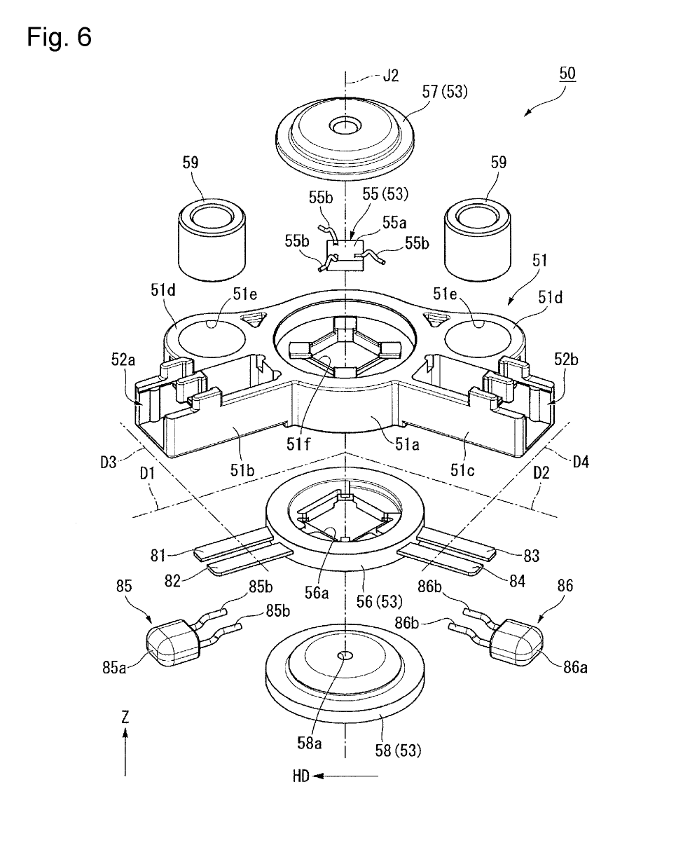

As shown in FIG. 6, the pressure sensor 53 includes a terminal support 56, a sensor chip 55, an upper side cover 57, and a lower side cover 58. The terminal support 56 has an annular shape in which the sensor central axis J2 passes through its center. The terminal support 56 has a support through-hole 56a that penetrates the center of the terminal support 56 in the vertical direction. The shape of the support through-hole 56a when viewed from the upper side is a substantially square shape. The terminal support 56 supports the first terminal 81, the second terminal 82, the third terminal 83, and the fourth terminal 84. As shown in FIG. 7, the terminal support 56 is embedded in a sensor housing part 51a (to be described below) of the sensor case 51.

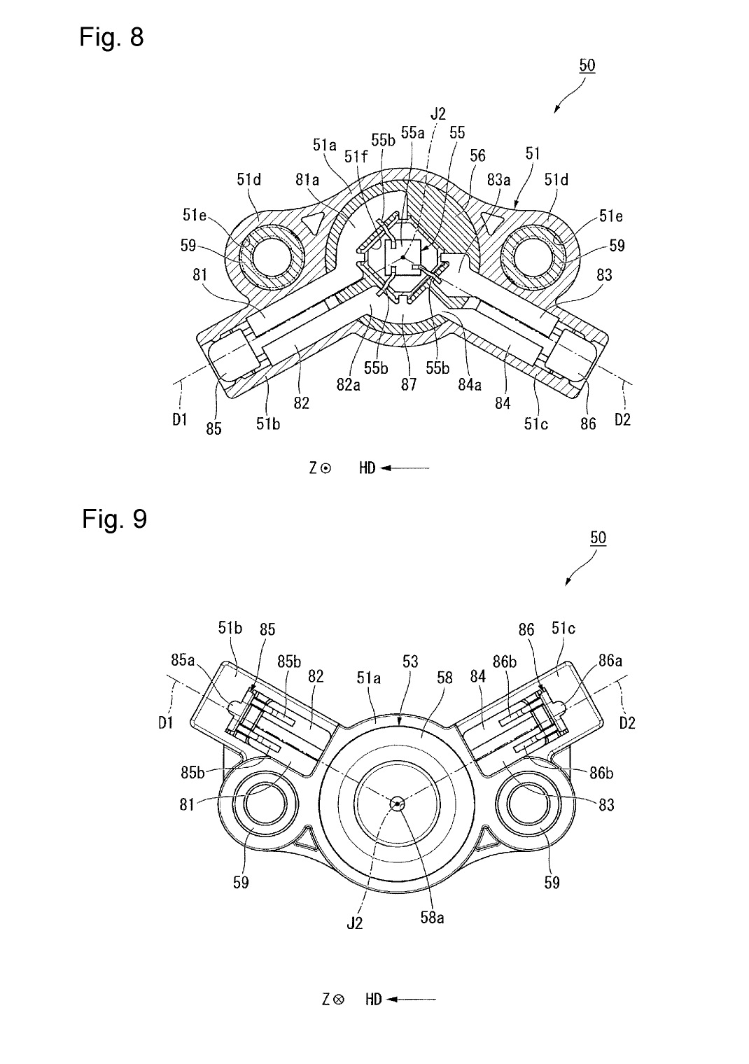

As shown in FIG. 6, the sensor chip 55 includes a square plate type sensor chip main body 55a, and three chip terminals 55b that are electrically connected to the upper surface of the sensor chip main body 55a. As shown in FIG. 7, the sensor chip main body 55a is disposed inside the support through-hole 56a. The sensor chip main body 55a is disposed on the upper surface of the lower side cover 58. In FIG. 7, the sensor chip main body 55a blocks an upper end opening of a detection hole 58a (to be described below). As shown in FIG. 8, the three chip terminals 55b are electrically connected to the first terminal 81, the second terminal 82 and the fourth terminal 84, and the third terminal 83. Here, a material such as aluminum can be wire-bonded to form a chip terminal, and electrodes of the sensor chip 55 and the terminals 81 to 84 can be electrically connected.

As shown in FIG. 7, the upper side cover 57 is disposed above the sensor chip 55. The upper side cover 57 covers the upper side of the sensor chip 55. As shown in FIG. 6, the upper side cover 57 has a disc shape in which the sensor central axis J2 passes through its center. As shown in FIG. 7, the upper side cover 57 has an upper side recess 57a that is recesses from the center of the lower surface to the upper side. An outer circumferential edge part on the lower surface of the upper side cover 57 is in contact with the upper surface of the terminal support 56.

The lower side cover 58 is disposed below the sensor chip 55. As shown in FIG. 6, the lower side cover 58 has a disc shape in which the sensor central axis J2 passes through its center. As shown in FIG. 7, the lower side cover 58 includes the detection hole 58a that penetrates the lower side cover 58 in the vertical direction and a lower side recess 58b that is recessed from the center of the lower surface to the upper side. The lower end of the detection hole 58a opens into the lower side recess 58b. The upper end of the detection hole 58a is blocked by the sensor chip main body 55a as described above. As shown in FIG. 6, the shape of the detection hole 58a in a plan view is a circular shape in which the sensor central axis J2 passes through its center. Although not shown, the shape of the lower side recess 58b when viewed from the lower side is a circular shape in which the sensor central axis J2 passes through its center.

As shown in FIG. 7, while the pressure sensor device 50 is fixed into the sensor housing recess 37, an outer circumferential edge part of the lower side recess 58b within the lower surface of the lower side cover 58 comes in contact with the bottom of the sensor housing recess 37. An O-ring 71 is disposed inside the lower side recess 58b. The O-ring 71 has an annular shape along the inner circumferential edge of the lower side recess 58b. The O-ring 71 comes in contact with the bottom of the sensor housing recess 37 and the top surface of the lower side recess 58b and seals a gap between the lower side cover 58 and the pump body 31. The upper end of the detection oil path 93 opens to the inside of the lower side recess 58b.

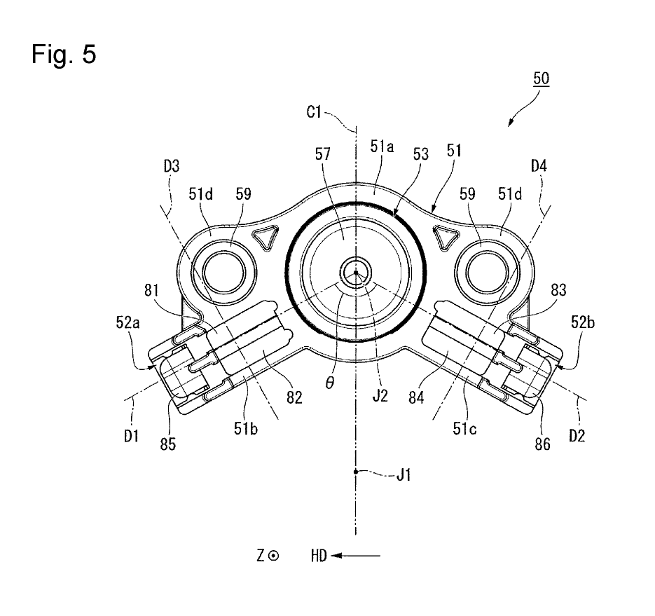

As shown in FIG. 6, the first terminal 81 to the fourth terminal 84 are flat plates orthogonal to the vertical direction. In the first terminal 81 to the fourth terminal 84, the inner end in the radial direction around the sensor central axis J2 is embedded and fixed to the inside of the pressure sensor 53. As shown in FIG. 5 and FIG. 8, the first terminal 81 and the second terminal 82 project in a first direction D1 that extends from the pressure sensor 53 to one side in the horizontal direction. The third terminal 83 and the fourth terminal 84 project in a second direction D2 that extends to the other side in the horizontal direction. More specifically, as shown in FIG. 6, the first terminal 81 and the second terminal 82 project from the terminal support 56 in the first direction D1. The third terminal 83 and the fourth terminal 84 project from the terminal support 56 in the second direction D2.

As shown in FIG. 5, the first terminal 81 and the second terminal 82 are disposed side by side in a third direction D3 orthogonal to both the first direction D1 and the vertical direction. The third terminal 83 and the fourth terminal 84 are disposed side by side in a fourth direction D4 orthogonal to both the second direction D2 and the vertical direction. The first terminal 81, the second terminal 82, the third terminal 83, and the fourth terminal 84 are disposed on the same horizontal plane orthogonal to the vertical direction in which the plate surface is parallel to the horizontal plane orthogonal to the vertical direction.

Here, in the present embodiment, the horizontal direction is, for example, a horizontal direction HD orthogonal to an imaginary line C1 connecting the central axis J1 and the sensor central axis J2 in a plan view shown in FIG. 5, that is, a left to right direction in FIG. 5. In the present embodiment, one side in the horizontal direction is the positive side (+HD side) in the horizontal direction HD, that is, the left side in FIG. 5, and the other side in the horizontal direction is the negative side (−HD side) in the horizontal direction HD, that is, the right side in FIG. 5.

In addition, in the present embodiment, the first direction D1 that extends to one side in the horizontal direction is one of a plurality of horizontal directions orthogonal to the vertical direction, and is one of directions that extend from the sensor central axis J2 which is the center of the pressure sensor 53 to an area on the right side (+HD side) of the imaginary line C1. In FIG. 5, the first direction D1 extends from the sensor central axis J2 to the left side inclined toward the central axis J1 (the lower side in FIG. 5) with respect to the horizontal direction HD orthogonal to the imaginary line C1. The first direction D1 is one of radial directions around the sensor central axis J2.

In addition, in the present embodiment, the second direction D2 that extends to the other side in the horizontal direction is one of a plurality of horizontal directions orthogonal to the vertical direction and one of directions that extend from the sensor central axis J2 which is the center of the pressure sensor 53 to an area on the right side (−HD side) of the imaginary line C1. In FIG. 5, the second direction D2 extends from the sensor central axis J2 to the right side inclined toward the central axis J1 (the lower side in FIG. 5) with respect to the horizontal direction HD orthogonal to the imaginary line C1. The second direction D2 is one of radial directions around the sensor central axis J2. An angle θ formed by the first direction D1 and the second direction D2 is an obtuse angle.

Here, in the following description, a side in the first direction D1 that is closer to the sensor central axis J2 with respect to a certain object will be referred to as the “inner side in the first direction” and a side away from the sensor central axis J2 with respect to a certain object will be referred to as the “outer side in the first direction.” In addition, a side in the second direction D2 closer to the sensor central axis J2 with respect to a certain object will be referred to as the “inner side in the second direction” and a side away from the sensor central axis J2 with respect to a certain object will be referred to as the “outer side in the second direction.”

As shown in FIG. 8, almost all of a first supported part 81a which is a part of the first terminal 81 on the inner side in the first direction is embedded in the terminal support 56 and supported by the terminal support 56. The first supported part 81a extends in the circumferential direction around the sensor central axis J2. An inner edge part of the upper surface of the first supported part 81a in the radial direction around the sensor central axis J2 is exposed from the terminal support 56. One of the chip terminals 55b is electrically connected to the exposed part of the upper surface of the first supported part 81a.

Almost all of a second supported part 82a which is an end of the second terminal 82 on the inner side in the first direction is embedded in the terminal support 56 and supported by the terminal support 56. An inner edge part of the upper surface of the second supported part 82a in the radial direction around the sensor central axis J2 is exposed from the terminal support 56. One of the chip terminals 55b different from the chip terminal 55b connected to the first supported part 81a among the chip terminals 55b is connected to the exposed part of the upper surface of the second supported part 82a.

Almost all of a third supported part 83a which is an end of the third terminal 83 on the inner side in the second direction is embedded in the terminal support 56 and supported by the terminal support 56. An inner edge part of the upper surface of the third supported part 83a in the radial direction around the sensor central axis J2 is exposed from the terminal support 56. The remaining one of the chip terminals 55b different from the chip terminal 55b connected to the first supported part 81a and the chip terminal 55b connected to the second supported part 82a among the chip terminals 55b, is connected to the exposed part of the upper surface of the third supported part 83a.

Almost all of a fourth supported part 84a which is an end of the fourth terminal 84 on the inner side in the second direction is embedded in the terminal support 56 and supported by the terminal support 56. An inner edge part of the upper surface of the fourth supported part 84a in the radial direction around the sensor central axis J2 is exposed from the terminal support 56. The fourth terminal 84 is electrically connected to the second terminal 82. More specifically, the second supported part 82a and the fourth supported part 84a are connected with a connection part 87 therebetween and thus the second terminal 82 and the fourth terminal 84 are electrically connected. The fourth terminal 84 is electrically connected to the second terminal 82, and thus electrically connected to the chip terminal 55b connected to the second terminal 82.

The connection part 87 extends in the circumferential direction around the sensor central axis J2. In the present embodiment, the second terminal 82, the fourth terminal 84, and the connection part 87 are made of the same member. The first terminal 81, the second terminal 82, and the third terminal 83 are disposed apart from and insulated from one another. The first terminal 81, the fourth terminal 84, and the third terminal 83 are disposed apart from and insulated from one another.

As shown in FIG. 5, the first terminal 81 and the second terminal 82 are disposed on one side of the pressure sensor 53 in the circumferential direction. The third terminal 83 and the fourth terminal 84 are disposed on the other side of the pressure sensor 53 in the circumferential direction. In the present embodiment, one side of the pressure sensor 53 in the circumferential direction is a side that moves counterclockwise around the central axis J1 from the pressure sensor 53 when viewed from the upper side. The other side of the pressure sensor 53 in the circumferential direction is a side that moves clockwise around the central axis J1 from the pressure sensor 53 when viewed from the upper side.

A power supply lead wire for supplying power to the pressure sensor device 50, a ground lead wire for grounding the pressure sensor device 50, and an output lead wire for outputting a value of a pressure measured by the pressure sensor device 50 as an electrical signal are connected to three terminals among the above four terminals. As an example, the first terminal 81 is a terminal to which the power supply lead wire is connected. The second terminal 82 is a terminal to which the ground lead wire is connected. The third terminal 83 is a terminal to which the output lead wire is connected.

The first capacitor 85 is disposed on one side (+HD side) of the pressure sensor 53 in the horizontal direction and is connected between the first terminal 81 and the second terminal 82. The second capacitor 86 is disposed on the other side (−HD side) of the pressure sensor 53 in the horizontal direction and is connected between the third terminal 83 and the fourth terminal 84.

As described above, according to the present embodiment, the terminals extend from the pressure sensor 53 in the first direction D1 and the second direction D2 which are one of the horizontal directions. Therefore, the pressure sensor device 50 can be made small in the vertical direction. In addition, four terminals project two at a time from the pressure sensor 53 in the first direction D1 and the second direction D2 toward the sides that are opposite to each other in the horizontal direction. Therefore, compared to when four terminals are disposed to project in the same direction, the pressure sensor device 50 can be made smaller in the vertical direction and the radial direction. In addition, the first capacitor 85 and the second capacitor 86 can be disposed on the sides that are opposite to each other in the horizontal direction with respect to the pressure sensor 53 by projecting four terminals two at a time in the first direction D1 and the second direction D2. Therefore, compared to when the first capacitor 85 and the second capacitor 86 are disposed on the same side of the pressure sensor 53, the pressure sensor device 50 can be made smaller in the vertical direction and the radial direction. Therefore, according to the present embodiment, the pressure sensor device 50 can be made small both in the vertical direction and the radial direction, and can be formed into a flat and elongated shape as a whole. Therefore, if the pressure sensor device 50 is disposed in the electrically powered pump 10 in the circumferential direction of the central axis J1, when the pressure sensor device 50 is disposed in the electrically powered pump 10, it is possible to prevent the size of the electrically powered pump 10 from becoming larger.

Specifically, as in the present embodiment, when the first terminal 81 and the second terminal 82 are disposed on one side of the pressure sensor 53 in the circumferential direction, and the third terminal 83 and the fourth terminal 84 are disposed on the other side of the pressure sensor 53 in the circumferential direction, the pressure sensor device 50 can be disposed in the circumferential direction. Thereby, it is possible to prevent the size of the electrically powered pump 10 from becoming larger and it is possible to dispose the pressure sensor device 50 in the electrically powered pump 10. In particular, as in the present embodiment, when an angle θ formed by the first direction D1 and the second direction D2 is an obtuse angle, the shape of the entire pressure sensor device 50 can be easily similar to the shape in the circumferential direction and the pressure sensor device 50 is easily disposed in the sensor housing recess 37 that extends in the circumferential direction. Thereby, it is possible to prevent the size of the electrically powered pump 10 from becoming larger.

In addition, as described above, in the present embodiment, the first terminal 81 and the second terminal 82 are disposed side by side in the third direction D3 orthogonal to both the first direction D1 and the vertical direction. In addition, the third terminal 83 and the fourth terminal 84 are disposed side by side in the fourth direction D4 orthogonal to both the second direction D2 and the vertical direction. Therefore, the pressure sensor device 50 can be made easily smaller in the vertical direction compared to when the terminals are disposed side by side in the vertical direction. In addition, the first terminal 81, the second terminal 82, the third terminal 83, and the fourth terminal 84 are disposed on the same horizontal plane orthogonal to the vertical direction. Therefore, the pressure sensor device 50 can be made easily smaller in the vertical direction.

As shown in FIG. 6, the first capacitor 85 includes a first capacitor main body 85a and two first connection terminals 85b. The first capacitor main body 85a is disposed on an extension line of the first terminal 81 and the second terminal 82 in the first direction D1. The two first connection terminals 85b extend from the first capacitor main body 85a to the inner side in the first direction. The two first connection terminals 85b are disposed side by side in the third direction D3.

The second capacitor 86 includes a second capacitor main body 86a and two second connection terminals 86b. The second capacitor main body 86a is disposed on an extension line of the third terminal 83 and the fourth terminal 84 in the second direction D2. The two second connection terminals 86b extends from the second capacitor main body 86a to the inner side in the second direction. The two second connection terminals 86b are disposed side by side in the fourth direction D4.

As shown in FIG. 9, one of the two first connection terminals 85b is connected to an end of the lower surface of the first terminal 81 on the outer side in the first direction. The other of the two first connection terminals 85b is connected to an end of the lower surface of the second terminal 82 on the outer side in the first direction. Thereby, the first capacitor 85 is connected between the first terminal 81 and the second terminal 82.

One of the two second connection terminals 86b is connected to an end of the lower surface of the third terminal 83 on the outer side in the second direction. The other of the two second connection terminals 86b is connected to an end of the lower surface of the fourth terminal 84 on the outer side in the second direction. Thereby, the second capacitor 86 is connected between the third terminal 83 and the fourth terminal 84.

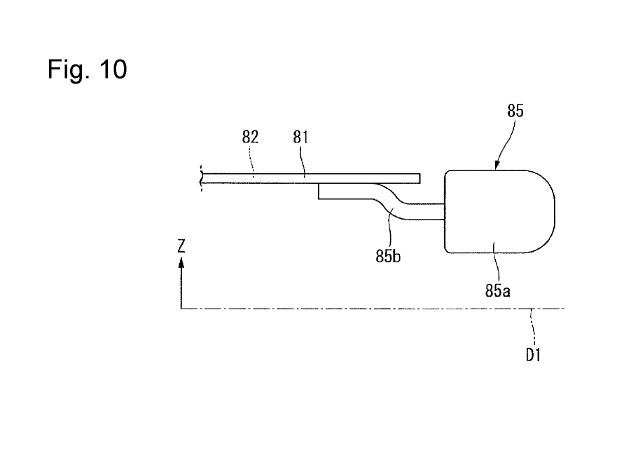

As shown in FIG. 10, the first capacitor main body 85a overlaps the first terminal 81 and the second terminal 82 in the first direction D1, that is, the first capacitor 85 overlaps both the first terminal 81 and the second terminal 82 when viewed in the first direction D1. Although not shown, the second capacitor main body 86a overlaps the third terminal 83 and the fourth terminal 84 in the second direction D2. That is, when viewed in the second direction D2, the second capacitor 86 overlaps both the third terminal 83 and the fourth terminal 84. In this manner, when the capacitors overlap the connected terminals in the horizontal direction, the pressure sensor device 50 can be made easily smaller in the vertical direction. Thereby, it is possible to prevent the size of the electrically powered pump 10 from becoming larger.

Here, when viewed in the first direction D1, the first capacitor 85 may overlap at least one of the first terminal 81 and the second terminal 82, or overlap only one of the first terminal 81 and the second terminal 82. In addition, when viewed in the second direction D2, the second capacitor 86 may overlap at least one of the third terminal 83 and the fourth terminal 84, or overlap only any one of the third terminal 83 and the fourth terminal 84. Even in such cases, the pressure sensor device 50 can be easily made smaller in the vertical direction, and it is possible to prevent the size of the electrically powered pump 10 from becoming larger.

The upper end of the first capacitor main body 85a is disposed at substantially the same position as the upper surface of the first terminal 81 and the upper surface of the second terminal 82 in the vertical direction. Although not shown, the upper end of the second capacitor main body 86a is disposed at substantially the same position as the upper surface of the third terminal 83 and the upper surface of the fourth terminal 84 in the vertical direction. The first capacitor 85 and the second capacitor 86 can prevent generation of a surge current.

As shown in FIG. 6, the sensor case 51 has the sensor housing part 51a, a first terminal housing part 51b, a second terminal housing part 51c, and a pair of fixing parts 51d. The sensor housing part 51a has a substantially cylindrical shape centered on the sensor central axis J2. The sensor housing part 51a houses the pressure sensor 53. More specifically, as shown in FIG. 7, a part of the pressure sensor 53 is embedded and held in the sensor housing part 51a. The sensor housing part 51a has a housing part through-hole 51f that penetrates the center of the sensor housing part 51a in the vertical direction. As shown in FIG. 8, the shape of the housing part through-hole 51f when viewed from the upper side is a substantially square shape in which the sensor central axis J2 passes through its center. The sensor chip main body 55a is disposed inside the housing part through-hole 51f in the radial direction around the sensor central axis J2.

As shown in FIG. 7, the lower side cover 58 is embedded and held in a lower part of the sensor housing part 51a. The lower surface of the lower side cover 58 is exposed from the sensor housing part 51a. The upper surface of the lower side cover 58 covers the lower end of the housing part through-hole 51f. The terminal support 56 is embedded and held in an upper part of the sensor housing part 51a.

The upper surface of the lower side cover 58, the inner surface of the sensor housing part 51a, the inner surface of the terminal support 56, and the lower surface of the upper side cover 57 constitute a housing space 72 in which the sensor chip 55 is housed. Although not shown, a sealing component covering the sensor chip 55 is disposed in the housing space 72.

As shown in FIG. 4 and FIG. 5, the first terminal housing part 51b extends from the sensor housing part 51a in the first direction D1. The first terminal housing part 51b has a rectangular box shape that is long in the first direction D1. The first terminal housing part 51b houses the first terminal 81, the second terminal 82, and the first capacitor 85. The first terminal housing part 51b has a first capacitor holding part 52a that holds the first capacitor 85. The first capacitor holding part 52a is an end of the first terminal housing part 51b on the outer side in the first direction.

The second terminal housing part 51c extends from the sensor housing part 51a in the second direction D2. The second terminal housing part 51c has a rectangular box shape that is long in the second direction D2. The second terminal housing part 51c houses the third terminal 83, the fourth terminal 84, and the second capacitor 86. The second terminal housing part 51c has a second capacitor holding part 52b that holds the second capacitor 86. The second capacitor holding part 52b is an end of the second terminal housing part 51c on the outer side in the second direction.

As described above, since the sensor case 51 has housing parts in which the pressure sensor 53, the terminals and the capacitors are housed, a gap between the pressure sensor device 50 and a member to which the pressure sensor device 50 is fixed can be insulated by the sensor case 51. Thereby, for example, even if the pump body 31 is made of a metal, without separately providing an insulation measure, the pressure sensor device 50 can be fixed to the pump body 31, and the electrically powered pump 10 can be easily assembled.

The pair of fixing parts 51d project from the sensor housing part 51a to both sides in the horizontal direction HD. A circular fixing hole 51e that penetrates the fixing part 51d in the vertical direction is provided in the pair of fixing parts 51d. As shown in FIG. 8, a cylindrical member 59 is fixed into the fixing hole 51e. As shown in FIG. 6, the cylindrical member 59 has a cylindrical shape that opens at both ends in the vertical direction. As shown in FIG. 2 and FIG. 3, the screw 70 for fixing the pressure sensor device 50 to the pump body 31 passes through the inside of the cylindrical member 59 from the upper side and is fastened to the female screw hole 37a.

While the pressure sensor device 50 shown in FIG. 7 is fixed to the pump body 31, oil flowing from the detection oil path 93 into the sensor housing recess 37 flows in the detection hole 58a. More specifically, oil flowing from the detection oil path 93 into the lower side recess 58b of the lower side cover 58 flows in the detection hole 58a. Since the upper end of the detection hole 58a is blocked by the sensor chip 55, oil flowing into the detection hole 58a comes in contact with the sensor chip 55. Thereby, the sensor chip 55 detects a pressure of oil flowing from the detection hole 58a. In this manner, a pressure of oil in the electrically powered pump 10 can be measured using the pressure sensor device 50.

In the present embodiment, since the O-ring 71 that seals a gap between the lower side cover 58 and the pump body 31 is disposed in the lower side recess 58b, it is possible to prevent oil flowing into the lower side recess 58b from leaking to the outside of the sensor housing recess 37. In addition, since a sealing component (not shown) covering the sensor chip 55 is disposed in the housing space 72, it is possible to prevent metal parts such as the sensor chip 55 and the chip terminal 55b from being oxidized (corroded).

Here, the sensor chip 55 may indirectly detect a pressure of oil through, for example, a diaphragm. In this case, the upper end of the detection hole 58a is blocked by the diaphragm, and the sensor chip 55 is disposed in contact with the diaphragm from the upper side. Thereby, the sensor chip 55 can detect a pressure of oil flowing into the detection hole 58a through the diaphragm.

In addition, an angle θ formed by the first direction D1 and the second direction D2 may be an acute angle, a right angle, or a straight angle. In addition, the first direction D1 and the second direction D2 may be directions parallel to the horizontal direction HD.

Here, the pressure sensor device of the present invention is not limited to the electrically powered pump 10 that pressurizes and circulates oil according to the above embodiment as long as it is an electrically powered pump that circulates a fluid, and can be applied to any electrically powered pump.

In addition, the above configurations can be appropriately combined within a range in which they are not mutually exclusive.

Priority is claimed on Japanese Patent Application No. 2016-147530, filed Jul. 27, 2016, the content of which is incorporated herein by reference.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-8. (canceled)

9. A pressure sensor device for an electrically powered pump, the pressure sensor device comprising:
a pressure sensor to measure a pressure of a fluid inside the electrically powered pump;
a first terminal and a second terminal that project from the pressure sensor in a first direction that extends to one side in a horizontal direction;
a third terminal that projects from the pressure sensor in a second direction that extends to the other side in the horizontal direction;
a fourth terminal that projects from the pressure sensor in the second direction and is electrically connected to the second terminal;
a first capacitor that is disposed on one side of the pressure sensor in the horizontal direction and is connected between the first terminal and the second terminal; and
a second capacitor that is disposed on the other side of the pressure sensor in the horizontal direction and is connected between the third terminal and the fourth terminal.

10. The pressure sensor device according to claim 9, wherein an angle defined by the first direction and the second direction is an obtuse angle.

11. The pressure sensor device according to claim 9, wherein the first capacitor when viewed in the first direction overlaps at least one of the first terminal and the second terminal; and
the second capacitor when viewed in the second direction overlaps at least one of the third terminal and the fourth terminal.

12. The pressure sensor device according to claim 9, wherein
the first terminal and the second terminal are disposed side by side in a direction orthogonal to both the first direction and a vertical direction; and
the third terminal and the fourth terminal are disposed side by side in a direction orthogonal to both the second direction and the vertical direction.

13. The pressure sensor device according to claim 12, wherein the first terminal, the second terminal, the third terminal, and the fourth terminal are disposed on a same horizontal plane orthogonal to the vertical direction.

14. The pressure sensor device according to claim 9, wherein the pressure sensor includes:
a sensor chip;
an upper side cover that is disposed on an upper side of the sensor chip; and
a lower side cover that is disposed on a lower side of the sensor chip; wherein
the lower side cover has a detection hole which penetrates the lower side cover in the vertical direction and into which the fluid is capable of flowing; and
the sensor chip detects a pressure of the fluid flowing from the detection hole.

15. The pressure sensor device according to claim 9, further comprising:
a sensor case that houses the pressure sensor and including:
a sensor housing portion that houses the pressure sensor;
a first terminal housing portion that extends from the sensor housing portion in the first direction and houses the first terminal, the second terminal, and the first capacitor; and
a second terminal housing portion that extends from the sensor housing portion in the second direction and houses the third terminal, the fourth terminal, and the second capacitor.

16. An electrically powered pump comprising:
a shaft that rotates around a central axis that extends in a vertical direction;
a motor that rotates the shaft;
a pump that is positioned on one side of the motor in the vertical direction and is driven by the motor via the shaft; and
the pressure sensor device according to claim 9; wherein
the first terminal and the second terminal are disposed on one side of the pressure sensor in a circumferential direction;
the third terminal and the fourth terminal are disposed on the other side of the pressure sensor in the circumferential direction; and
the pressure sensor device is disposed in the electrically powered pump.
